(19) United States
(12) Patent Application Publication
(10) Pub. No.: US 2012/0085218 A1
(43) Pub. Date: Apr. 12, 2012

(54) LIGATURE FOR THE MOUTHPIECES OF SINGLE-REED WIND INSTRUMENTS

(76) Inventor: Florian Popa Tudor, Alava (ES)

(21) Appl. No.: 13/376,198

(22) PCT Filed: May 27, 2010
(86) PCT No.: PCT/ES2010/070356

§ 371 Date: Dec. 5, 2011

(30) Foreign Application Priority Data
Jun. 4, 2009 (ES) P200930263

(51) Int. Cl. G10D 9/02

(52) U.S. Cl. 84/383 R

(57) ABSTRACT

The invention relates to a ligature for the mouthpieces of single-reed wind instruments, consisting of a rigid closed ligature in the form of a slightly conical ring with a slightly convex wall, in which the ligature is made from ebony and is provided externally with two central circles on the convex part, as well as four upper circles and two smaller circles. The shape and material of the ligature provide a substantial improvement in terms of sound and greater strength in relation to a traditional ligature.

### SUBJECT MATTER OF THE INVENTION

The subject matter of the invention is a ligature for the mouthpieces of single-reed wind instruments, that use a single reed and is specified only for clarinets and saxophones.

The present invention for a ligature for the mouthpieces of wind instruments is characterised by the special configuration, design and materials used in its manufacture so that ease of emission, quality, pitch, power, flexibility of sound is achieved in a proportion of from 20 to 30% approximately, by improving one of the parts considered to be accessories, as is the case of the ligature, the aim of this invention.

Therefore, this invention is circumscribed within the field of musical instruments and particularly among wind instruments, specifically the clarinet and saxophone, and more precisely, of an accessory such as the ligature.

### BACKGROUND TO THE INVENTION

Since their definition as such, clarinets and saxophones have undergone a great deal of development in their construction and improvement, to obtain the instruments that we know today. Over the years, these improvements have been made by clarinettists and saxophonists who have worked in order to improve the technical features of these instruments in all their aspects.

Today, most clarinettists and saxophonists consider without a doubt that these instruments cannot be improved any more and that as a consequence, their development has been completed.

In order to gain a better understanding of the ligature, subject matter of the invention, it is necessary to understand the sound emission process of the clarinet and saxophone.

The sound is characterised by:

A. Height

B. Intensity

C. Pitch

A. Loudness is a subjective quality of the sound which is perceived as low or high conveyed in the music by means of a number of signs called notes. The sound is given by the emitting part, through the air compression/decompression number that creates a number of vibrations (variable of sound waves), vibrations that reach the ear in the form of sound. These vibrations are called frequencies. The number of frequencies in cycles per second are called Hertz. Hertz determine the notes of the musical scale in accordance with their number (from 16 to 20,000 per second for the human ear).

B. Intensity is the quality that indicates to us the strength or weakness of the sound. In music, slight perception is represented by P (piano) and high perception of the sound is represented by F (forte). Scientifically, intensity corresponds to the power with which the sound is emitted or received, as energy that crosses (penetrates) the space (surface) in meters per unit of time. For musicians, intensity relates to the projection of sound.

C. Pitch. This is easy to distinguish and difficult to explain, but recognisable by one's ear with sufficient precision. Scientifically, due to its frequency, intensity and through the vibration of the instrument, sound penetrates in the space accompanied by a superimposition of single waves (in a sinuous manner) that have different intensities and frequencies. The waves that accompany the main wave are bigger and have different intensities and frequencies, which determine the differences of pitch.

Taking these properties into consideration, one can understand the exceptional importance of accessories such as the mouthpiece, reed and ligature, which provide at the same time ease of use, quality in the mission of sound and, therefore, the traditional flexible ligature has been used all these years.

Sound tube instruments, such as the clarinet and saxophone, are classified in:
tubes, those that have only one opening
open tubes, those that have two or more openings

The shape of these tubes may be cylindrical or conical and at the same time with a mouthpiece with a double or single reed.

The clarinet and the saxophone are peculiar instruments for the following reasons:

1. They are mouthpiece and single reed instruments at the same time.

2. They are considered closed tubes although in reality they operate like open tubes.

The clarinet and the saxophone seem to be a closed tube but at the top they have a mouthpiece to which a reed is fitted, secured with a ligature and in this way have a small slit between the reed and the mouthpiece, an opening that is almost blocked. The air pressure that passes between the reed and the mouthpiece joined together with a ligature, creates a resonance (sound waves) within the tube that vary (modulate) in accordance with the pressure.

The reed is secured by a ligature to the mouthpiece and in the case of the saxophone and clarinet the reed is single.

The mouthpiece of wind instruments is the portion of tube modified with the aim of inserting the lower part in the instrument and the upper part between the lips (mouth) of the performer.

The reed has its own frequency as it is associated with a sound tube (mouthpiece) secured to this with a ligature and has a predominant influence on the frequency, sound and pitch of the instrument.

Therefore, the reed and ligature associated with the mouthpiece play an important role as accessories in facilitating the quality, flexibility, uniformity and pitch of the instrument.

Having established the exceptional importance of these accessories: mouthpiece, reed and ligature, I must point out that over the centuries, no changes have appeared in their traditional and/or material form, especially in the case of the ligature, in spite of its vital importance.

The ligature is a part, considered accessory or complementary, which secures the reed in the housing provided for in the mouthpieces. Ligatures must exercise a specific and uniform pressure on the reed (which is a bamboo cane) and mouthpiece.

Taking into consideration that the reed and ligature create a determined frequency (sound) in the mouthpiece, the quality of this sound will depend largely on the ligature, hence the importance of the shape and material used to make the ligature.

Since the 17th century and to the present day, ligatures have been flexible and made of different materials: metal, cord, plastic, leather, etc.

These ligatures have undergone small changes in their design and aesthetics, but not in their concept, despite their undoubted importance in the creation and emission of the sound.

The conventional ligature for clarinet and saxophone mouthpieces (therefore for single reed instruments), is a ligature made from a flexible material which incorporates the mouthpieces in order to secure the reed in the nozzle housing. This ligature, initially opened, includes one or two butterfly nuts, which are arranged perpendicularly to the axis of the mouthpiece. These butterfly nuts are inserted in the thread of the ligature and by tightening, gradually close this, securing the reed to the mouthpiece.

The only use of this ligature is that it secures the reed and allows the instrument to be used, without taking into consideration the influence and importance of this accessory.

This flexible ligature, which we might call traditional, is not trouble-free and involves a number of difficulties, such as:
The materials with which it is made are not vibratory, i.e., good sound transmitters, taking into consideration that the mouthpiece, reed and ligature together create the sound.
The central pressure on the reed is not uniform.
Taking into consideration the memory materials have, the reed, which is a bamboo cane, does not recognise the molecules of such different materials.
The fact that the ligature is flexible and open, although joined by means of butterfly nuts, it does not transmit perfect sound waves to the mouthpiece of the instrument, it deforms these, bearing in mind that the sound waves are propagated to the instrument in a spiral manner and if small obstacles are found, these are deformed, with undesired consequences.
The butterfly nuts and threads contribute enormously to the disturbance of sound waves and their harmonics, as these are obstacles to the passage of sound waves.
The butterfly nuts that secure the ligature are in a position below the lower lip of the mouthpiece and on many occasions touch the chin and are very uncomfortable.
Being made of metal, butterfly nuts rust after a time, even the threads, and therefore these operate incorrectly as well as having an influence on emission.

Therefore, the aim of this invention is to overcome the aforementioned disadvantages, by developing a literature as described in the first claim, making this with vibratory materials, making the pressure on the reed uniform, allowing the perfect transmission of the sound waves to the mouthpiece of the instrument, as ergonomically as possible and without the need for mechanical elements for their adjustment.

### DESCRIPTION OF THE INVENTION

The ligature invention for the mouthpieces of wind instruments that use single reeds consists basically of a closed, rigid ligature in the form of a slightly conical ring and with a wall curved slightly outwards.

The material is ebony wood, the only one that has the optimum parameters for the substantial improvement of the sound. It also has greater strength, taking into consideration that this standard ligature must secure the reed to the mouthpiece with a certain amount of firmness and physical pressure.

The proposed ligature is for the mouthpieces of clarinets and their family of instruments and for the saxophone and its family of instruments.

The most widely used clarinets are:
Eb in Eflat and D
Clarinet in Bflat and A
Bass clarinet

The most widely used saxophones are:
Soprano saxophone in Bflat
Alt saxophone in Eflat
Tenor saxophone in Mat
Baritone saxophone in Eflat

The mouthpieces used in all clarinets and saxophones are identical and the only thing that differentiates them is the dimension of the central axis (length) and the circumference. All the other concepts are the same.

The standard ligature prototype proposed is for clarinets in Bflat and A (used in most widely in 90% of cases) and the high saxophone with ligature (clamp) similar to that of clarinets in Bflat and A.

Within the ligature subject of the invention, there is a housing for the reed.

The advantages of this close, rigid model in comparison with the traditional, open and flexible model, are as follows:

1. The closed, rounded and compact ligature secures the reed with much greater precision, gently but firmly, transmitting to the mouthpiece and by implication to the instrument, a total uniformity of vibrations as it is a uniform ligature in its concept. Therefore, it transmits the sound gently as there are no obstacles to deform the sound waves.

2. The type of material, Although rigid, ebony wood, which is an excellent sound conductor, is the same material used to make the instrument, in the case of the clarinet. As it is rounded in shape (similar to the sound waves), slightly conical and with specific dimensions, it transmits the sound forming a common body with the reed and mouthpiece. This fact improves substantially the ease with which the sound is created. Its flexibility and emission.

3. As the ligature is made from ebony wood and the reed is made from bamboo cane, they have a similar molecular density that combine and recognise each other, having a similar resonance that is very important in the creation, flexibility and emission of sound.

4. As it is made from wood and does not have any other added element, it is very easy to fit. Moreover, due to its size and low weight, it does not create the inconvenience of the traditional, flexible ligature with butterfly nuts (threaded screws).

### EXPLANATION OF THE FIGURES

As an aid in the description to be made below and in order to provide for a better comprehension of its characteristics, a set of drawings are attached to this descriptive report. Its figures, which are illustrative and in no way limited, show the most significant details of the invention.

FIG. 1, shows a representation of a mouthpiece on which a “traditional” literature is mounted.

FIG. 2 shows a representation of a reed.

FIG. 3, shows a representation of the elements and shape of a traditional ligature.

FIG. 4 shows a representation of the ligature subject of this invention.

FIG. 5 shows a representation of the mounted assembly of mouthpiece, read together with the ligature subject of the invention.

### PREFERENTIAL REALISATION OF THE INVENTION

With reference to the figures, a preferable realisation of the proposed invention is described.

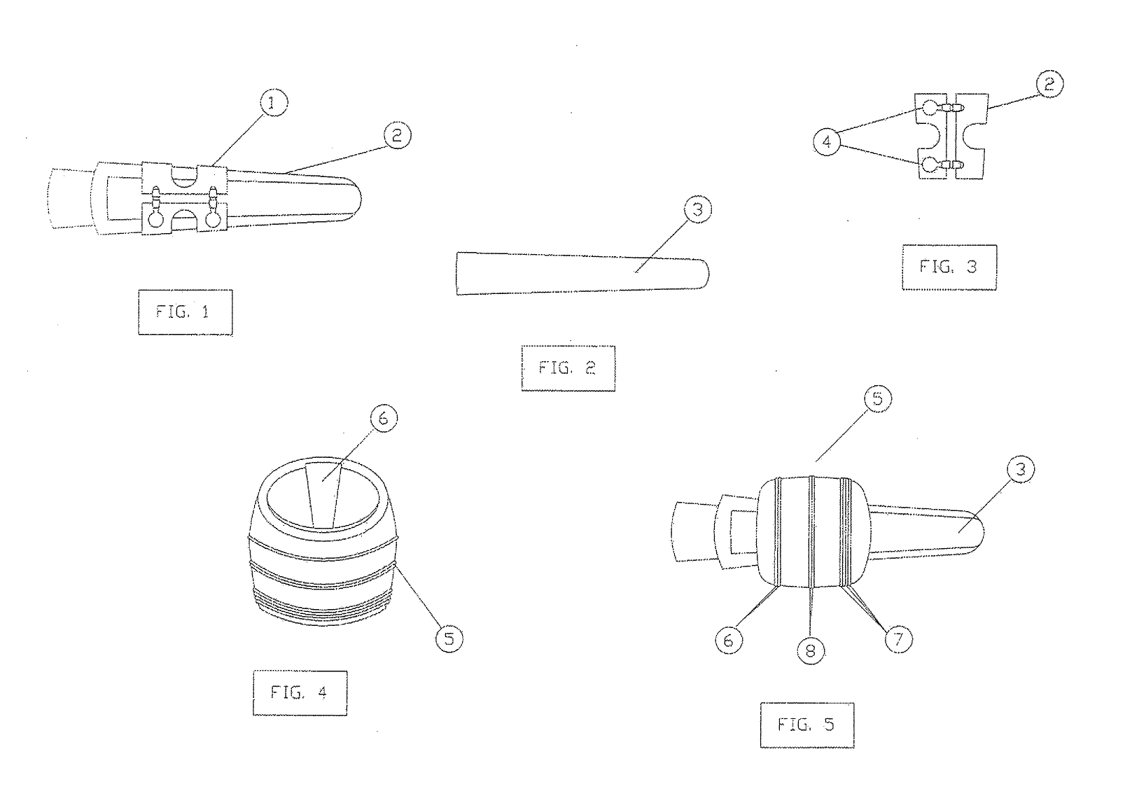

In FIG. 1, we can see a mouthpiece (1) on which a traditional ligature is secured (2) and which is responsible for securing the reed to the sound tube or mouthpiece (1). Together with the mouthpiece and ligature, the reed is responsible for facilitating the quality, flexibility and uniformity and pitch of the instrument.

In FIG. 2, we can observe a reed (3), which is generally made from bamboo cane, thanks to which the ligature (5), subject of the invention (FIG. 4) is made from ebony wood, which is an excellent conductor of sound, both combine a similar molecular density which has such an important influence on the flexibility and emission of the sound.

In FIG. 3, we can observe the form of a traditional ligature (2) which is metallic and comprises two butterfly nuts (4) used for securing this. This type of ligature involves a number of disadvantages as described above, as they are not made from vibratory materials, nor do they exercise a uniform pressure on the reed, nor do they transmit perfect sound waves to the mouthpiece about deform these; these butterfly nuts can be uncomfortable and cause the instrument to operate incorrectly due to rest or similar defects.

FIG. 4 shows a prospective representation of the ligature (5), subject of the invention, which is made from ebony wood; it has a generally conical configuration which is defined by its height, width of the upper edge, width of the lower edge and the thickness of the wall.

In view of the fact that the width of one edge is greater than the width of the other edge it is said that it has a generally conical configuration.

In FIG. 5, the assembly of the mouthpiece (1), reed (3) and ligature (5) can be seen, all mounted, where it is seen that the ligature that has two central external circles (8) in the convex part, with four upper circles (7) and two smaller circles (6).

Variations in materials, form, size and arrangement of the component elements described in a non-limiting manner, do not alter the essential nature of this invention, this being based for its reproduction by an expert.

1. Ligature for the mouthpieces of wind instruments that use a single reed characterised because it presents a closed, rigid configuration, in the form of a slightly conical ring, as the width of one edge is lower than the width of the other edge, it is made from ebony wood and internally presents a housing for the reed.

2. Ligature for the mouthpieces of wind instruments that use a single reed according to the first claim characterised because externally it has two central, outer circles (8) in the convex part, with four upper circles (7) and two smaller circles (6).
